(19) United States
(12) Patent Application Publication
(10) Pub. No.: US 2005/0071203 A1
(43) Pub. Date: Mar. 31, 2005

(54) Insurance marketplace

(76) Inventor: Kevin Maus, Revere, MA (US)

Correspondence Address: FISH & RICHARDSON PC, 225 FRANKLIN ST, BOSTON, MA, 02110, US

(21) Appl. No.: 10/676,370

(22) Filed: Sep. 30, 2003

(51) Int. Cl. G06F 17/60

(52) U.S. Cl. 705/4

(57) ABSTRACT

An insurance marketplace is facilitated by providing an interface to allow a server system to receive a request from an insurance producer, operating in a jurisdiction, to place an insurance policy of a specific type in the jurisdiction, and to transmit to the producer authorization from a broker who is licensed in the first jurisdiction to produce the insurance policy.

### FIELD OF INVENTION

This invention relates to placement of insurance policies.

### BACKGROUND

Surplus lines insurance refers to insurance that is placed with an insurance carrier that is not licensed (or “admitted”) in a particular jurisdiction. Many state laws in the United States require an insurance carrier to have a license from the state to write insurance on risks located in the state. In some situations, it may not be possible to find an admitted insurance carrier in the state that is willing to underwrite a particular type or amount of insurance that an insured intends to purchase. State laws permit the insured to purchase, from “non-admitted” insurance carriers, a surplus lines policy for risks that are surplus or excess to what the admitted insurance carriers are willing to write. Thus, surplus lines insurances can be used as a source of additional insurance capacity and as a primary coverage for high-hazard or unusual risks.

A state has limited authority to regulate the surplus line insurers because those insurers act as foreign corporations in the states where they function as surplus lines insurers. States regulate the surplus lines insurance business by imposing certain duties on brokers of surplus lines policies. For example, a state may require the brokers to ensure that a “diligent search” of the admitted market has been performed before placing the business with a surplus lines insurer. In such a case, the broker would have to file affidavits stating that the insurance sought by the insured is not available from admitted insurers. In another example, some states do not collect premium tax from surplus lines insurers, but require the brokers themselves to collect and submit surplus lines taxes. Furthermore, some states require that each surplus lines policy be stamped by a surplus lines association or stamping office.

Some states maintain an export list that describes certain types of insurance, or classes of risks, that the insurance department regards as not generally available in the admitted market. The types of insurance on the list can be routinely placed with non-admitted insurers, and are exempt from the diligent search requirement, so that no affidavits are required. Some states laws have an “industrial insured exception,” which specifies that affidavits are not required if the insured is a large corporation, has an in-house risk manager, and has an annual revenue above a certain level.

In many states, non-admitted insurers are not included in the state's guaranty fund that protects insured when an insurance company becomes insolvent. Many states require the surplus lines brokers to place a stamp on the surplus lines policy declaration page advising the insured that the insurance company is not licensed in the state and the guaranty fund does not apply. Some states require that the surplus lines broker ensure that the non-admitted insurer's policy consents to jurisdiction of the courts in the insured's state for disputes arising under the policy and also consents to service of legal process on the Insurance Commissioner. Some states require that the surplus lines policies be maintained by the brokers. Because of the special legal requirements associated with the production of surplus lines insurance policies, it is typically more complicated and time consuming for an insurance producer to obtain a surplus lines policy for a customer, as compared to other types of insurance. In one common scenario, when an insurance producer receives a request from an insured (an applicant) to purchase a surplus lines insurance policy, the producer finds an insurance broker who has a surplus lines broker's license in the state where the risk is located (e.g., when property insurance is sought) or the state where the insured resides (e.g., when casualty insurance is sought). The broker then finds a surplus lines insurance company that provides the type of insurance coverage sought by the insured. The surplus lines broker license is required in addition to a regular broker's license. The broker also needs a brokerage agreement with the surplus lines insurance company.

Typically, the producer calls the broker and asks for an application form. The broker mails the application form to the producer, who fills out the application form and mails it back to the broker. The broker mails the application form to an underwriter of the surplus lines insurance company. The underwriter may reject the application, or accept the application and generate a quote for insurance premium. The underwriter may ask the broker questions about the insured, revise the application to add endorsements and deductions. The underwriter mails the quote to the broker, who mails the quote to the producer. The producer may accept the quote (on behalf of an insured), or may revise the application and ask for another quote based on the new submission.

After the producer accepts the quote, the producer mails to the broker affidavits stating that the producer diligently searched the admitted market and tried to place the insurance with admitted insurance companies, but was unsuccessful. The underwriter generates a bound policy, and mails a copy of the bound policy to the broker. The broker places a special stamp on the policy if required to by state law, and forwards a copy of the policy to the producer, who in turn forwards a copy of the policy to the insured. The broker files the policy and the due diligence affidavits with the relevant state insurance department. The broker also collects premium tax from the insurance company or the insured and files it with the state insurance department.

The foregoing process can be time consuming and expensive to implement. In addition, a producer may not be able to locate a broker who is best able to meet the needs of a given customer.

### SUMMARY

In general, in one aspect, the invention features a system for facilitating an insurance marketplace that allows insurance retail producers, insurance brokers, and insurance companies to collaborate over a network to complete placement of insurance policies. The system may provide user-friendly graphical user interfaces to allow entry and sharing of data and documents among different parties involved in the process of placement of the insurance policies. The system may match a producer to a broker and an insurance company based on the type of insurance to be placed or the particular jurisdiction in which the risk is located. For surplus lines insurance policies, the system may follow procedures to ensure that the placement of the insurance policies comply with surplus lines regulations in the relevant jurisdiction.

In general, in another aspect, the invention features a computer implemented method that includes receiving at a server a request from an insurance producer, operating in a first jurisdiction, to place an insurance policy of a specific type in the first jurisdiction. The method may include transmitting to the producer authorization from a broker who is licensed in the first jurisdiction to produce the insurance policy.

This and other aspects of the invention may include one or more of the following features.

The method includes, in response to the request at the server, automatically identifying one or more brokers who are licensed to place the specific type of insurance policy in the first jurisdiction.

The insurance producer is not licensed in the first jurisdiction to broker insurance policies of the specific type.

The method includes providing a graphical user interface (GUI) to the insurance producer to allow the insurance producer to enter the request.

The GUI allows the insurance producer to enter information related to an insured entity of the insurance policy.

The GUI is provided to the producer over the Internet.

The GUI is configured to be displayed by an Internet browser.

The insurance policy comprises a surplus lines insurance policy.

The surplus lines insurance policy includes a property and casualty insurance policy.

Identifying the broker comprises providing a database containing information sufficient to identify brokers who are licensed in the first jurisdiction to place policies of the specific type.

The database identifies brokers who have surplus lines broker's licenses in the first jurisdiction.

The database identifies brokers who have non-resident surplus lines broker's licenses in the first jurisdiction.

The database identifies brokers who have surplus lines broker's licenses in a second jurisdiction.

The method includes providing a database containing information describing legal requirements for placing policies of the specific type in the first jurisdiction.

The database contains information describing legal requirements for placing policies of the specific type in a second jurisdiction.

The method includes, at the broker, satisfying the legal requirements described in the database.

The method includes determining whether the insurance policy is exempt from a legal requirement described in the database.

Determining whether the insurance policy is exempt from a legal requirement comprises determining whether the specific type of insurance policy is listed on an export list that specifies the types of insurance that are exempt from a diligent search requirement.

Determining whether the insurance policy is exempt from a legal requirement comprises determining whether an insured entity qualifies for an industrial insured exception.

The method includes generating an affidavit or declaration to be signed by the producer or a representative of the producer, the affidavit or declaration being generated based on the legal requirements described in the database.

The affidavit or declaration contains a statement specifying that the broker was not able to find an insurance company licensed to provide insurance policies of the specific type in the first jurisdiction.

The method includes generating the insurance policy and relevant documents according to regulatory requirements of the first jurisdiction related to insurance policies of the specific type.

The relevant documents include an affidavit or declaration that contains a statement specifying that the broker was not able to find an insurance company licensed to provide insurance policies of the specific type in the first jurisdiction to underwrite the insurance policy.

The relevant documents include a tax form for paying tax related to the insurance policy.

The method includes rating the insurance policy based on a set of guidelines.

The method includes notifying an underwriter who underwrites the insurance policy when the insurance policy does not satisfy the set of guidelines.

The method includes providing a GUI to the underwriter to allow the underwriter to rate the insurance policy when the insurance policy does not satisfy the set of guidelines.

The method includes placing the insurance policy with an insurance company that is not licensed to underwrite insurance policies in the first jurisdiction.

The method includes sending a message to an underwriter of the insurance policy indicating that the insurance policy needs to be renewed.

The method includes sending an approval to the producing indicating that a renewal of the insurance policy has been approved.

The method includes registering an insured entity of the insurance policy with a reservation system to notify producers or brokers that are affiliated with the producer who produced the insurance policy that the insured entity has already been contacted regarding the insurance policy.

In general, in another aspect, the invention features a computer implemented method that includes receiving at a server computer a request from an insurance producer who is not licensed to place insurance policies to insure risks of a specific type in a jurisdiction, to place an insurance policy of the specific type in the jurisdiction. The method includes forwarding the request to a broker who is licensed to place the insurance policy of the specific type in the jurisdiction, and receiving from the broker authorization to produce the insurance policy.

This and other aspects of the invention may include one or more of the following features.

The method includes automatically identifying one or more brokers who are licensed to place the insurance policy of the specific type in the jurisdiction.

The method includes automatically identifying one or more insurance companies that are eligible to provide the insurance policy of the specific type in the jurisdiction.

Receiving from the broker authorization to produce the insurance policy includes receiving from the broker authorization that the broker received from the identified insurance company for producing the insurance policy.

The method includes receiving at the server a selection by the producer of a broker from the one or more identified brokers.

Identifying the broker includes searching a database containing contact information of brokers who have surplus lines broker's licenses.

The method includes generating the insurance policy according to a set of rules so that the insurance policy satisfies insurance regulations of the jurisdiction.

The method includes determining whether the insurance policy is exempt from a diligent search requirement that requires the broker to search for insurance companies licensed in the jurisdiction to underwrite the insurance policy.

Determining whether the insurance policy is exempt from the diligent search requirement includes determining whether the risk of the specific type is listed on an export list that specifies the types of insurance that are exempt from the diligent search requirement.

Determining whether the insurance policy is exempt from the diligent search requirement includes determining whether an insured entity qualifies for an industrial insured exception that specifies the types of insured entities that are exempt from the diligent search requirement.

The method includes, when the insurance policy is not exempt from a diligent search requirement, generating an affidavit or declaration that contains a statement specifying that the broker was not able to find an insurance company licensed to provide insurance policies of the specific type in the first jurisdiction to underwrite the insurance policy.

The method includes generating the insurance policy and relevant documents according to regulatory requirements of the first jurisdiction related to insurance policies of the specific type.

The documents include an affidavit or declaration that contains a statement specifying that the broker was not able to find an insurance company licensed to provide insurance policies of the specific type in the first jurisdiction to underwrite the insurance policy.

The documents include a tax form for paying tax related to the insurance policy.

The method includes rating the insurance policy based on a set of guidelines.

The method includes notifying an underwriter who underwrites the insurance policy when the insurance policy does not satisfy the set of guidelines.

The method includes providing a GUI to the underwriter to allow the underwriter to rate the insurance policy when the insurance policy does not satisfy the set of guidelines.

The method includes placing the insurance policy with an insurance company that is not licensed to underwrite insurance policies of the specific type in the first jurisdiction.

The method includes sending a message to an underwriter of the insurance policy indicating that the insurance policy needs to be renewed.

The method includes sending an approval to the producer indicating that a renewal of the insurance policy has been approved.

The method includes registering an insured entity of the insurance policy with a reservation system to notify producers or brokers that are affiliated with the producer who produced the insurance policy that the insured entity has already been contacted regarding the insurance policy.

In general, in another aspect, the invention features a computer implemented method that includes receiving at a server a request from an insurance producer to place a surplus lines insurance policy with an insurance company, automatically identifying one or more brokers who are licensed to place the surplus lines insurance policy, automatically identifying one or more insurance companies that are eligible to provide the surplus lines insurance policy, and transmitting to the producer authorization from one of the identified insurance companies to produce the insurance policy.

This and other aspects of the invention may include one or more of the following features.

Transmitting to the producer authorization from one of the identified insurance companies includes transmitting to one of the identified brokers the authorization from the identified insurance company, and transmitting to the producer the authorization from the identified broker.

In general, in another aspect, the invention features a server system that includes a first interface for receiving from a producer over a network a request to place an insurance policy of a specific type in a jurisdiction and to transmit to the producer, in response to the request, authorization from a broker who is licensed in the jurisdiction to produce the insurance policy.

This and other aspects of the invention may include one or more of the following features.

The server system includes a processing engine residing on or in communication with the server system, the processing engine configured to identify one or more brokers licensed in the first jurisdiction to place insurance policies with an insurance company not licensed to insure risks of the specific type in the jurisdiction.

The server system includes a second interface for providing information about a received request to an insurance broker.

The server system includes a third interface for providing information about a received request to an insurance underwriter and for allowing the insurance underwriter to authorize production of the insurance policy.

The server system includes a database containing contact information of at least one broker who has a surplus lines broker's license in the jurisdiction.

The server system includes a rating engine to rate the insurance policy when the request to place the insurance policy of the specific type meets a set of insurance guidelines.

The server system includes a database having templates of surplus lines insurance policies.

The templates of surplus lines insurance policies includes different templates of a common type of insurance policy to satisfy the insurance regulations or laws of different jurisdictions.

Other features and advantages of the invention are apparent from the following description, and from the claims.

### DESCRIPTION OF DRAWINGS

FIG. 1 shows surplus lines insurance marketplace.

FIG. 2 shows an insurance policy processing system.

FIGS. 3 and 4 show an insurance policy generation process.

FIGS. 5-11 show interactive web pages.

### DESCRIPTION

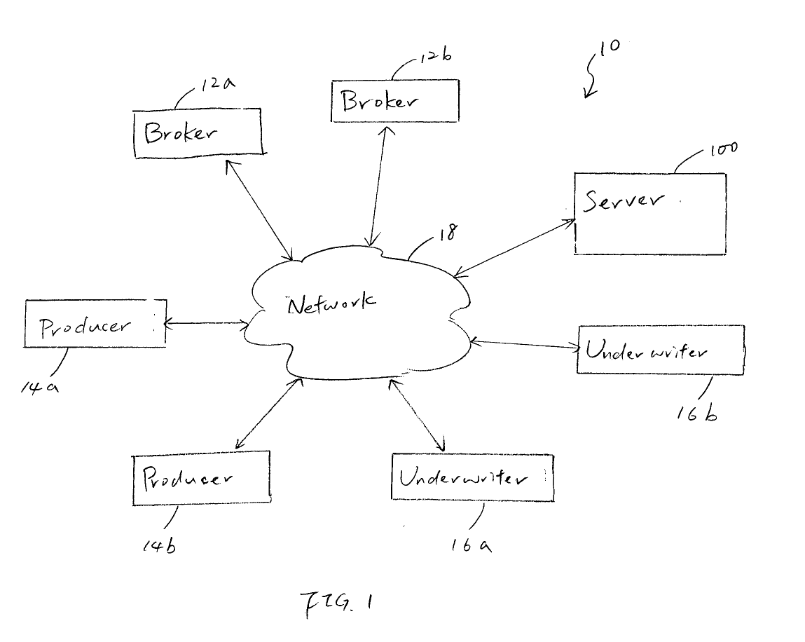

Referring to FIG. 1, a surplus lines insurance marketplace 10 is established by using a server 100 to provide tools that allow surplus lines insurance producers, licensed brokers, and surplus lines insurance underwriters to collaborate over a network 18 (e.g., the Internet) to complete placement of surplus lines polices. Server 100 streamlines processing of information necessary to place a surplus lines policy by matching a producer with the proper broker and underwriter, and providing a graphical user interface (GUI) to allow the producer, the broker, and the underwriter to conveniently enter insurance data and comments, and review and revise the insurance policy. Server 100 implements a process to ensure that the procedure for placing the policy complies with relevant regulations, and that relevant documents are filed with the regulatory authorities in compliance with the regulations.

In one version of marketplace 10, server 100 is operated by a national network of brokers who have surplus lines broker's licenses in various jurisdictions. The national network of brokers is affiliated with a surplus lines insurance company that has a number of underwriters specializing in the surplus lines insurance business. Server 100 includes a referral service that refers an insurance submission to an underwriter of an affiliated insurance company when the first insurance company does not provide the type of insurance coverage sought by the insured.

In the following description, the term “applicant” refers to an applicant of an insurance policy, and the term “insured” refers to an insured who has an insurance policy with the insurance company. The term “client” refers to both applicants and insured. The term “submission” refers to the collection of information submitted by a producer to the broker or underwriter for placement of an insurance policy, including information on the applicant and the amount of insurance coverage sought. The term “jurisdiction” refers to a geographical region over which a government body exercises legal authority to regulate the issuance of insurance policies.

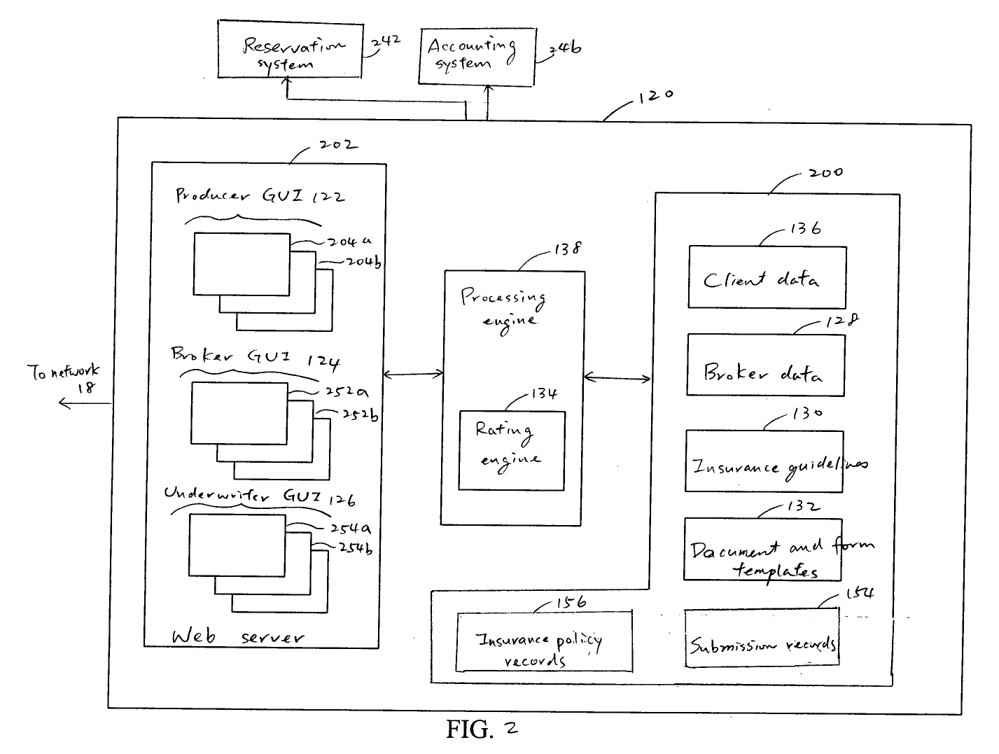

Referring to FIG. 2, server 100 implements an insurance policy processing system 120 that includes a web server 202, a processing engine 138, and a database 200. Web server 202 provides a producer GUI 122, a broker GUI 124, and an underwriter GUI 126, which provide interfaces to producers, brokers, and underwriters, respectively, to enter and retrieve data, and access the functionalities provided by system 120.

In one example, each of the GUIs includes a series of interactive web pages (e.g., 204a, 204b, 252a, 252b, 254a, 254b) that can be displayed by web browsers local to the producer, broker, or underwriter. Web server 202 interacts with processing engine 138 to process insurance data and generate relevant documents and forms. Processing engine 138 includes a rating engine 134 used to automatically rate insurance premiums for submissions that fall within predefined guidelines.

Database 200 stores client data 136, broker data 128, insurance guidelines 130, document and form templates 132, submissions 154, and insurance policy records 156. Client data 136 includes information on applicants and insured, such as their mailing and email addresses, phone and fax numbers, past insurance policies, credit ratings, and past claims histories. Forms include data fields that are filled in by the producer, broker, and underwriter. Examples of documents include premium quotes, insurance policies, and affidavits.

Broker data 128 includes information of brokers that have surplus lines broker's licenses in various jurisdictions. For each jurisdiction, a broker may be a resident of the jurisdiction, or can be a non-resident who has a non-resident broker's license. Broker data 128 includes information on the specialties of the brokers, and information on which insurance companies have brokerage agreements with the broker.

Insurance guidelines 130 specify the conditions in which quotes for insurance premiums for a submission can be provided. The guidelines may specify the conditions when system 120 can automatically calculate premium quotes based on predefined mathematical formulas, conditions when the submission needs to be referred to an underwriter to calculate the quote, and conditions when an insurance company will not provide insurance coverage of the type sought by the insured.

For example, a guideline may specify that certain insurance companies will not provide insurance coverage for risks incurred during pyrotechnics performances at a concert. A guideline may specify that for a certain type of property and casualty insurance, the submission needs to be referred to the underwriter when the coverage sought is greater than a preset dollar amount.

Document and form templates are used to generate instances of forms and documents. The forms are used to fill in client information, producer information, etc. The documents include insurance policies for different types of insurance programs, and documents that need to be filed with relevant regulatory agencies, such as affidavits, and tax forms.

Submission records 154 include submissions that are currently being processed. For example, a submission may be awaiting approval from an underwriter. By storing the submission in database 200, the submission is made available to any producer, broker, and underwriter who has access to the Internet and is authorized to view the submission data.

Insurance policy records 156 include records of policies that have been executed. When an insurance policy is due for renewal, system 120 notifies the producer who originally produced the insurance policy. The producer, as well as other producers or brokers or underwriters, can easily retrieve a description of the policy from database 200.

Data processed by processing engine 138 may be exported to other systems. For example, information can be sent to a reservation system 242 to reserve accounts or to an accounting system 246 for bookkeeping purposes.

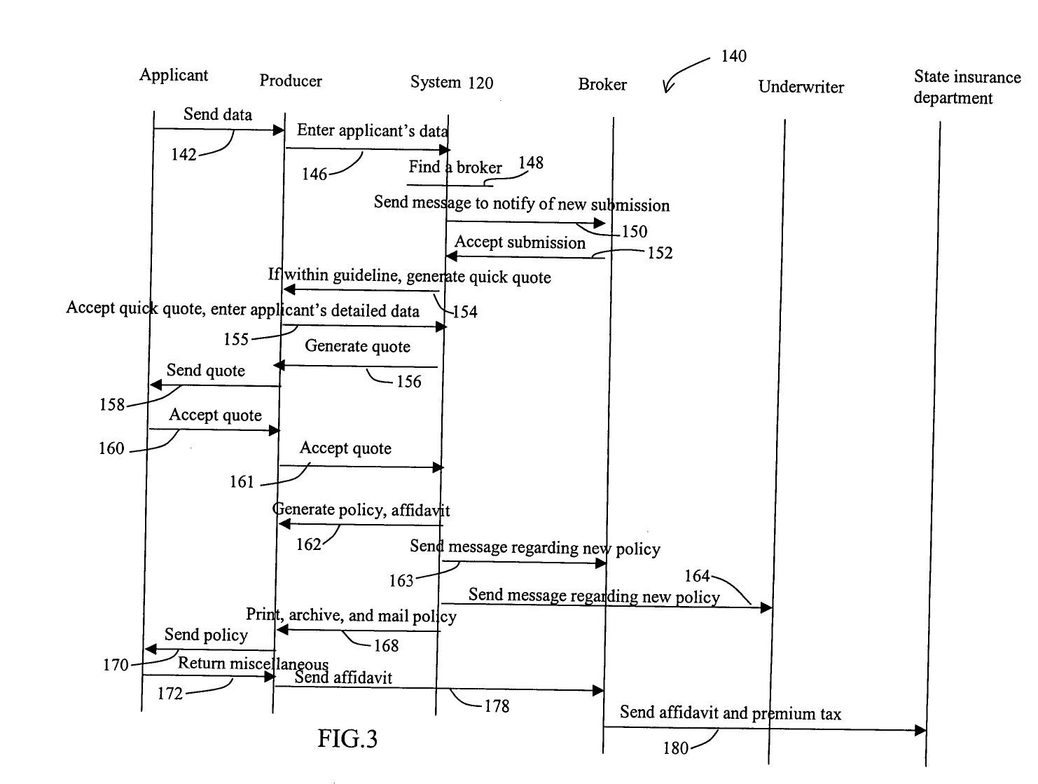

Referring to FIG. 3, system 120 implements an insurance policy generation process 140 to create a binding surplus lines insurance agreement. An applicant sends (142) insurance application information to a producer, and requests a quote for an insurance premium. The producer logs on to system 120 through producer GUI 122, and enters an acknowledgement that he has complied with the due diligence requirements of the relevant jurisdiction. The producer selects an insurance program (e.g., home inspectors liability or liquor liability), and enters (146) application data provided by the applicant (e.g., personal information, business information, type to risk sought to have insurance coverage).

During the log on process, system 120 determines whether the producer is currently registered to execute business with the insurance company. If the producer is not registered, a sign-up screen is displayed to allow the producer to register.

Upon receiving the submission, system 120 determines whether a submission for the same client already exists, as the client may contact a number of producers, and each producer may send a submission independently. Processing engine 138 accesses client data 136 and compare submissions under the same or similar client names. If processing engine 138 determines that there is a duplicate submission, system 120 sends a message to the producer saying that the submission is a duplicate, and that the submission will not be processed. Override functionality is provided so that the producer can still proceed with a quote under special circumstances.

System 120 evaluates the submission to determine whether the insurance company provides the type of insurance coverage sought by the applicant. If system 120 determines that the insurance company does not provide the type of insurance coverage sought by the applicant, system 120 will decline the submission. For example, the insurance company may have a policy of not providing insurance coverage for risks involved in pyrotechnics performances in a live concert.

If system 120 determines that the insurance company provides the type of insurance coverage sought by the applicant, system 120 reserves the submission with reservation system 242 so that an affiliated producer will not solicit the same business from the same applicant. When a submission is reserved, when the time comes for renewal, the original producer will be given priority in contacting the client about whether to renew the policy. To reserve the submission, system 120 searches client data 136 on all or part of the applicant 's name to see if there is an exact match, or a name that is similar enough to be a possible match. On possible matches, the addresses are compared. If there is no match, the applicant 's name and address is entered, and client data 136 is updated.

The process of entering applicant's data is a two-step process. The producer enters preliminary data to determine whether the insurance company will accept the type of insurance sought to be covered, then enters more detailed information if the insurance company accepts the preliminary submission. Upon receiving the preliminary data, system 120 attempts to find (148) a broker that is licensed in the relevant jurisdiction. The relevant jurisdiction may be the jurisdiction in which the risk is involved, or where the insured property is located. System 120 searches broker data 128 to find at least one broker that accepts submissions of the type of insurance program selected by the producer (e.g., home inspector's liability program or liquor liabilities program). If there are more than one broker who is capable of placing the insurance policy for the producer, the producer may be given a list of brokers to choose from.

After a suitable broker is found, system 120 notifies (150) the broker (such as by sending an email) about the submission from the producer. The broker logs on to system 120 through broker GUI 124, accesses the record containing the new submission, reviews the submission, and determines whether to accept the submission. If the broker does not accept the submission, system 120 looks for another broker.

If the broker accepts (152) the submission, system 120 determines whether the submission is within predefined insurance guidelines 130. If the submission is within the guidelines 130, system 120 automatically generates 154 a “quick quote,” which is not binding on the insurance company. The quick quote may include several quotes for combinations of premiums and deductibles. The quick quote is generated by the rating engine 134.

If the producer does not accept the quick quote, the producer may modify and re-enter the preliminary data, and request for another quick quote. If the producer accepts the quick quote, the producer enters 155 the applicant's detailed information. Rating engine 134 evaluates the applicant's detailed information, and if it is within the insurance guidelines, rating engine 134 automatically generates a formal quote which is transmitted to the producer. This quote is binding upon the insurance company.

After receiving the formal quote, the producer uses producer GUI 122 to prints out the formal quote and a cover letter (using document and form templates 132), and sends (158) them to the applicant. The applicant accepts the quote by signing it and mails or delivers it (160) back to the producer. The producer logs on to system 120 and accepts (161) the quote. System 120 generates 162 a binder or a draft insurance policy based on the submission and quote, using the document and form templates 132. The producer also accesses the document and form templates 132 to generate affidavits if required in the relevant jurisdiction.

After the binder has been generated, system 120 sends (163) a message (e.g., an email) to the broker to indicate that a new policy has been placed. The broker may log on to the system, and uses the broker GUI 124 to retrieve and review the policy. System 120 also sends (164) a message to the underwriter to indicate that a new policy has been generated. The underwriter logs on to system 120, uses underwriter GUI 126 to retrieve and review the policy. Instead of sending a message to the underwriter for each policy that is created, system 120 may periodically send statistical information regarding the policies. For example, system 120 may send a message to the underwriter every day to notify the underwriter about the policies that have been processed for each insurance program that day.

After the binder has been issued, system 120 sends relevant information to a printer server (or a third party specializing in printing insurance policies), which causes a formal insurance policy to be printed (168) based on the binder or the draft policy. The insurance policy is archived and an electronic copy of the policy is stored in database 200. A paper copy of the of the insurance policy may be stored in a file room of the insurance company. A paper copy of the insurance policy is mailed to the producer. The producer then mails (170) the copy to the applicant. The applicant may have to return (172) miscellaneous items to the producer. For example, in step 142, the applicant may have provided his information over the phone or using email. In step 170, the producer may notify the applicant that the insurance policy is not binding until a signed application form is returned.

After having completed any required affidavits, the producer sends (178) them to the broker. In a jurisdiction that requires the broker to maintain or file the insurance policy, the producer also sends a copy of the policy to the broker. The broker, in compliance with relevant surplus lines regulations, sends (180) the affidavits and premium tax (and the insurance policy, if required) to the relevant state insurance department. The premium tax may be collected from the producer or from the applicant (the insured) directly.

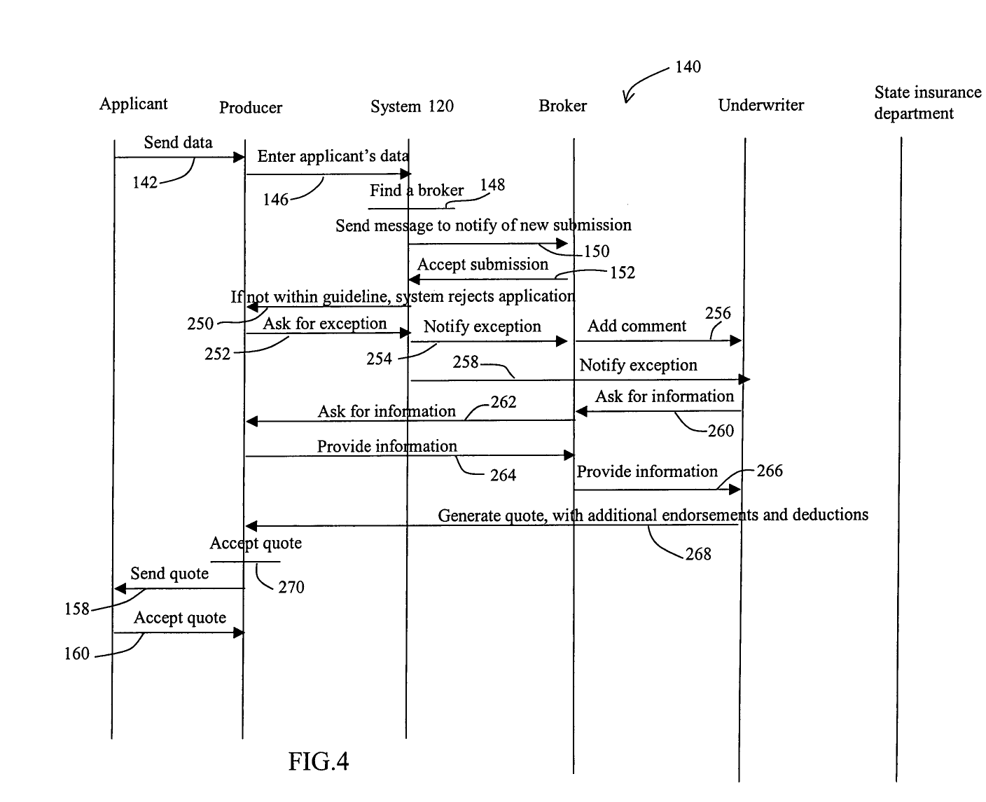

Referring to FIG. 4, if system 120 determines (182) that the submission is not within the guidelines, system 120 rejects (250) the application. The producer may modify the submission, or ask (252) for an exception. The producer can enter comments to say why the insurance company should accept the submission even though it does not fall within the guidelines. System 120 notifies (254) the broker about the exception. The broker logs on to system 120 through the broker GUI 124, retrieves the submission stored in database 200, reviews the submission, and may add comments (256), such as reasons for why the insurance company should accept the submission. For example, a guideline may specify that the insurance company does not provide coverage for liquor liability if the applicant's business is such that the applicant derives more than 25% of its revenue from liquor sales. The broker may enter a comment saying that although the applicant derives a high percentage of revenue from liquor sales, the applicant has an exceptionally good claims history, and thus does not present a high risk to the insurance company.

System (120) notifies (258) the underwriter about the exception. The underwriter logs on to system 120 through underwriter GUI 126, retrieves the submission stored in database 200, and reviews the submission and comments provided by the producer and broker. Since the submission is outside of the insurance guidelines, the underwriter may need more information in order to calculate the risk exposure to the insurance company. The underwriter requests (260) more information about the application, the broker forwards (262) the request for more information to the producer. The producer provides (264) information to the broker, who forwards (266) the information to the underwriter.

If the underwriter approves of the submission after reviewing all the information, the underwriter generates (268) a quote, often with additional endorsements and deductions. The quote is sent (158) to the producer. If the producer accepts (270) the quote, the producer sends (158) the quote to the applicant. The remaining steps are similar to the situation in which the submission falls within the guidelines. If the producer does not accept the quote, then the producer can enter additional comments, and repeat the process of steps 252 to 268.

The following are examples of web pages of the producer GUI 122.

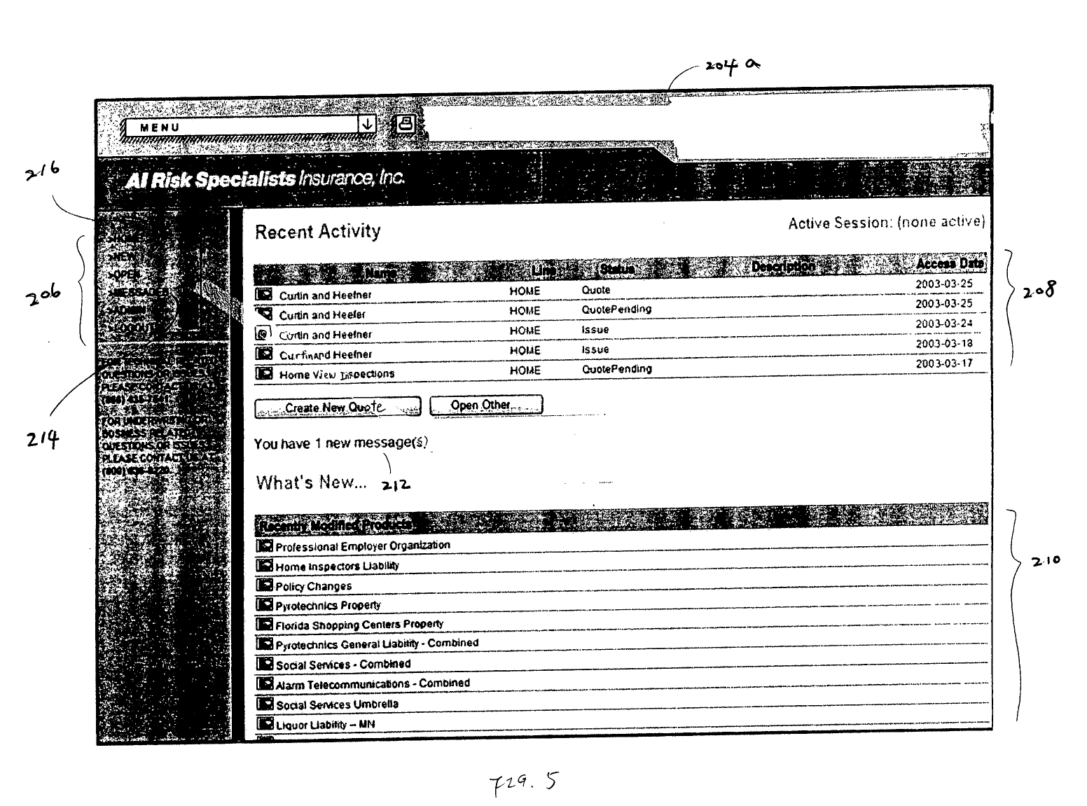

Referring to FIG. 5, a web page 204a provides a menu 206 for the producer to navigate the web pages of the producer GUI 122. A list 208 shows the recent activities 208, and a list 210 shows recently modified products. Web page 204a displays a notice 212 when the producer has a new message. Menu 206 includes a “messages” link 214, that links to a web page that shows the new messages. Menu 206 includes a “new quotes” link 216, which links to a web page for allowing the producer to process new quotes.

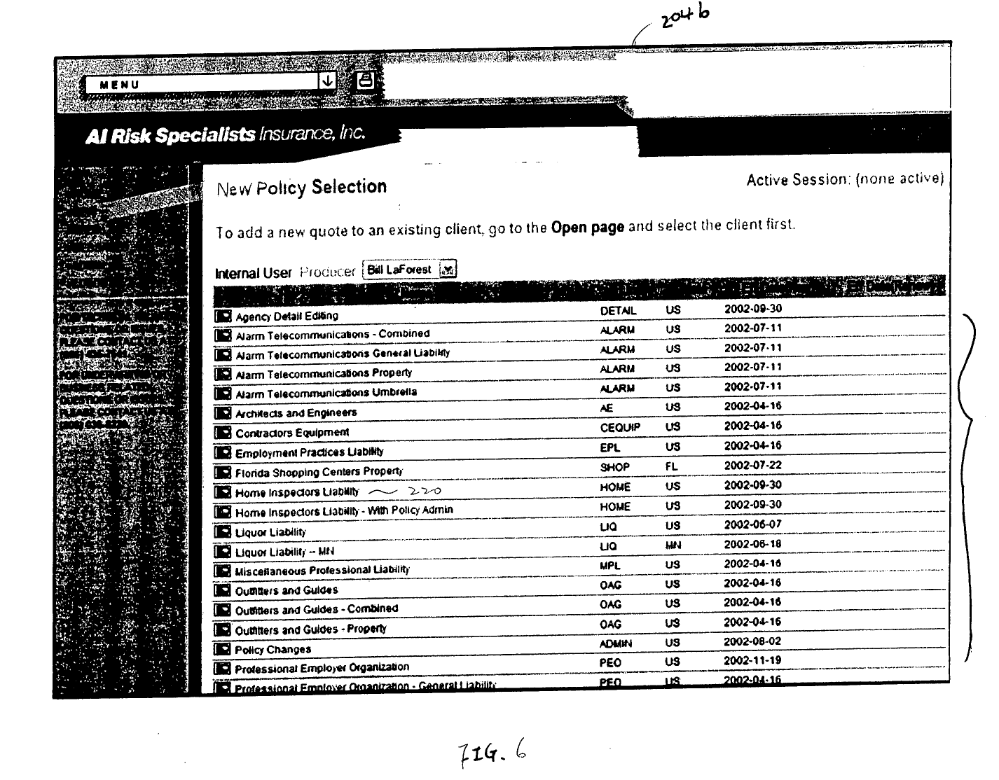

Referring to FIG. 6, a web page 204b displays a list 218 of insurance programs that the producer can choose from. The items of list 218 are linked to web pages for processing quotes for the respective program. For example, a “Home Inspectors Liability” link 220 links to a web page relevant to creating a new home inspectors liability insurance policy.

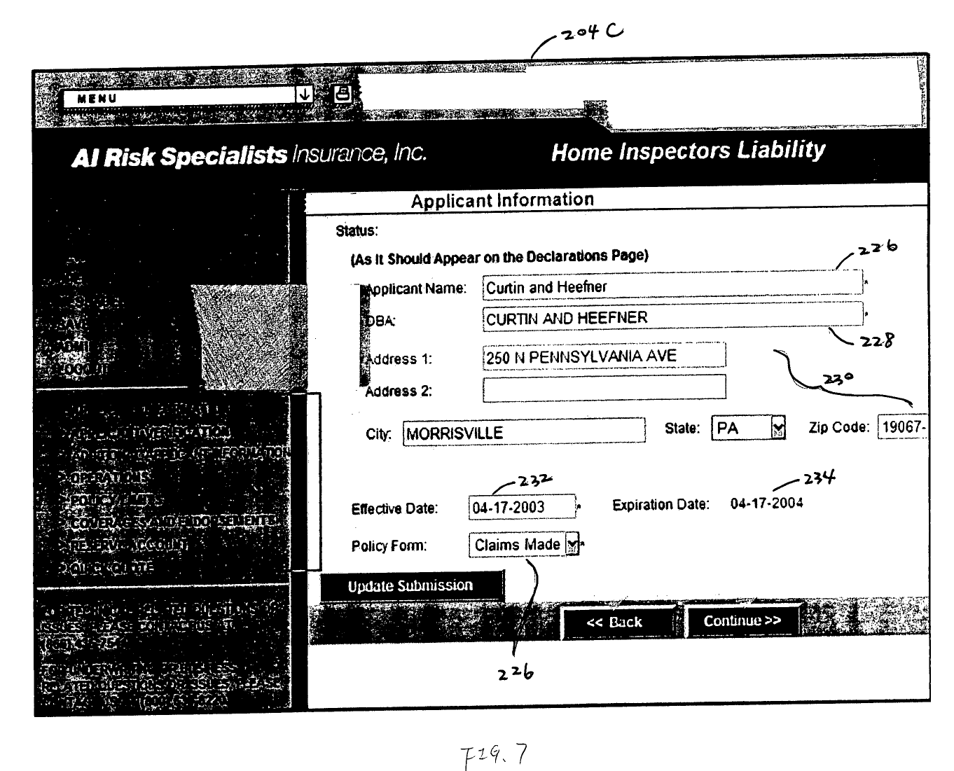

Referring to FIG. 7, when the producer selects the home inspectors liability program, a web page 204c is displayed for entering information of the applicant, including name 226, business name 228, address 230, policy effective date 232, policy expiration date 234, and policy form 226. Some of this information is used to generate declarations that are filed with state insurance departments in compliance with due diligence regulations.

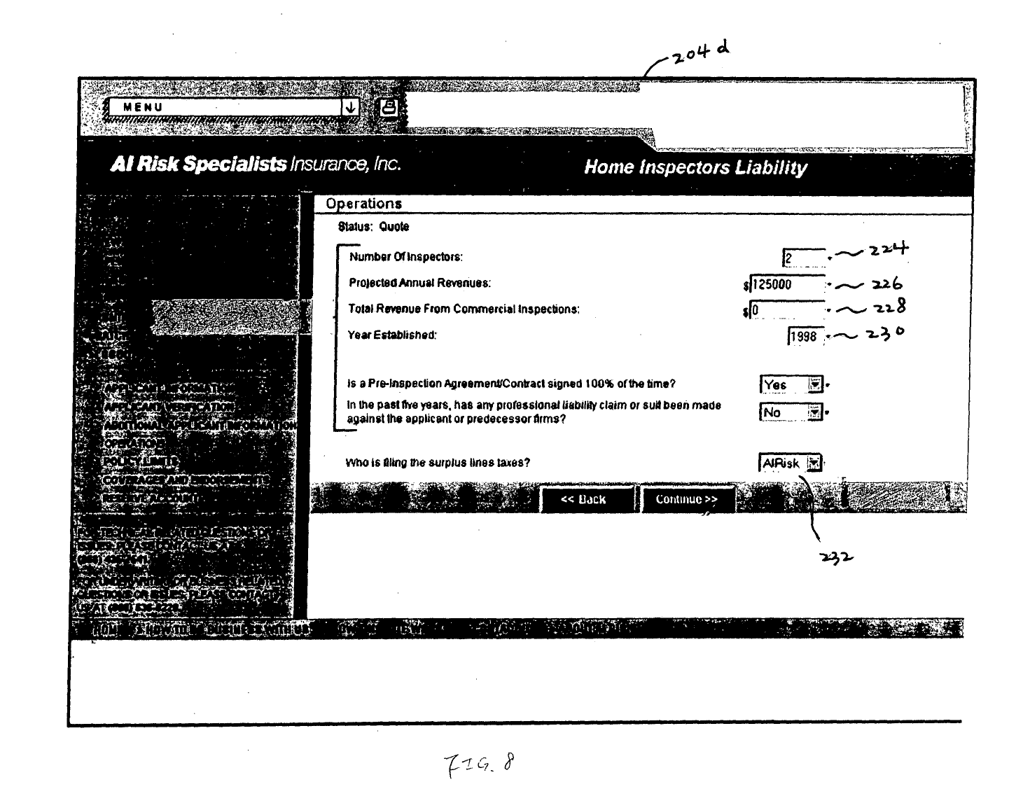

If the insured has a previous policy on file, the previous policy is called from the database 200 and displayed, and the producer can determine whether the policy is to be renewed or modified. For new policies, referring to FIG. 8, a web page 204d is displayed to allow the producer to enter information on the operations of the insured, such as the number of home inspectors 224, the projected annual revenues of the home inspectors service 226, the total revenue from commercial inspections 228, and the year that the home inspectors service was established 230. Web page 204d also includes a selection menu 232 to allow the producer to determine who files the surplus lines taxes.

A web page may be displayed to allow the producer to enter information related to the insurance policy limits, such as the combined policy limit of the home inspections service and the deductibles. A web page may be displayed to allow the producer to enter information on optional coverage and endorsements, such as whether the insurance policy covers premises liability, termite inspection, and radon inspection, and whether terrorism coverage is excluded. A web page may be displayed to allow the producer to enter information on the past claims history of the applicant.

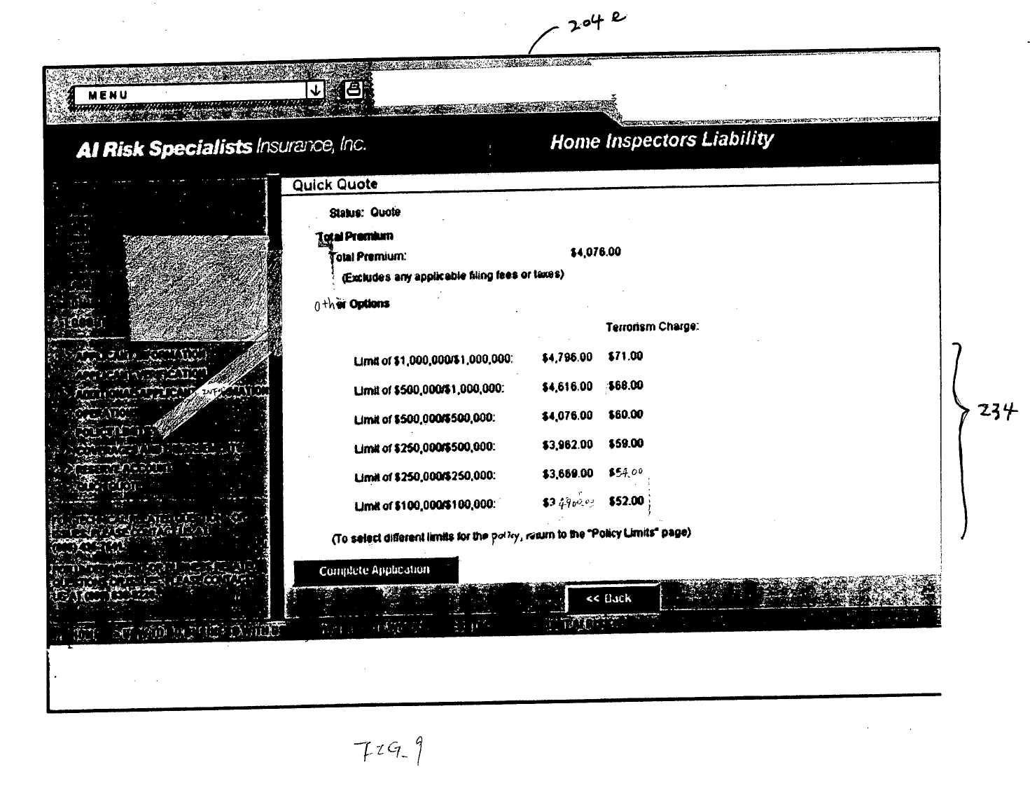

Referring to FIG. 9, if the submission falls within the insurance guidelines 130, the rating engine 134 calculates the premium rates, and generates a quote or quotes. A web page 204e is displayed to show quotes 234 for premiums.

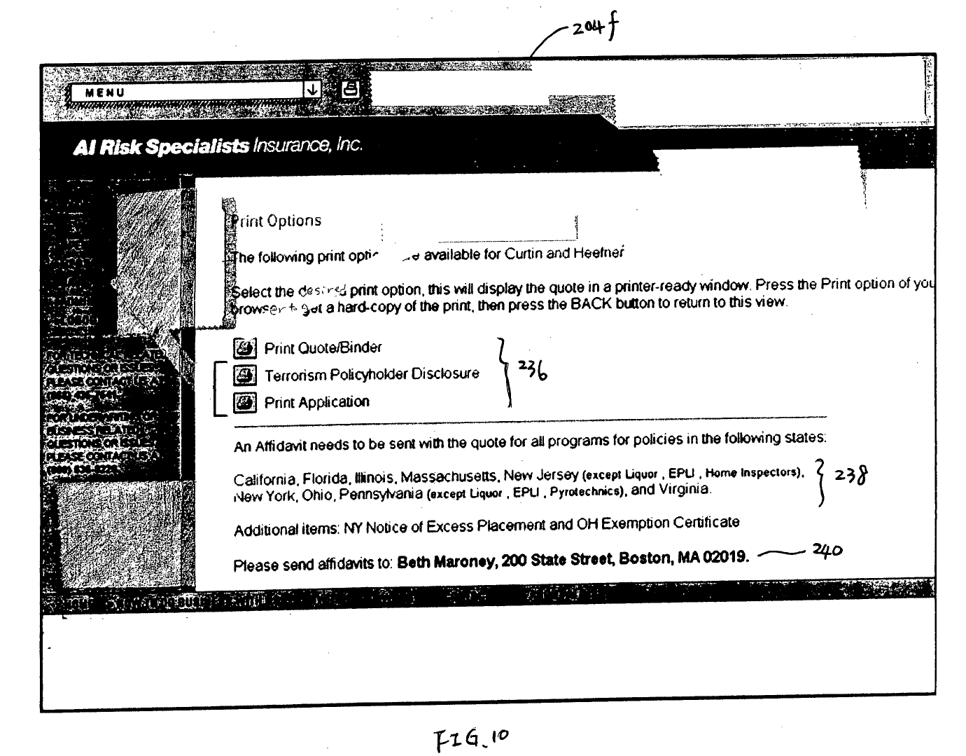

Referring to FIG. 10, after the producer has reviewed the quotes, a web page 204f is displayed to provide the producer a number of printing options. Web page 204f displays a list of state links 238 that link to web pages that show affidavits, which can be filed with particular state insurance departments. Web page 204f displays the mailing address of the broker 240, who actually files the affidavits with the state insurance department.

The following is an example of a web page of the underwriter GUI 126.

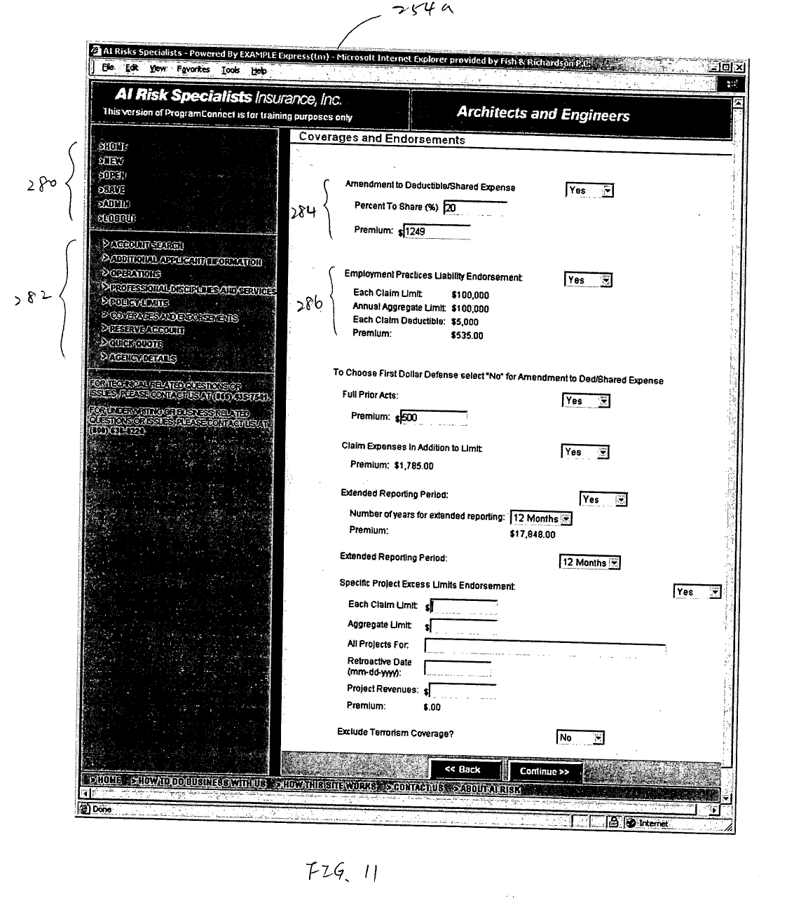

Referring to FIG. 11, a web page 254a displays coverage and endorsements that an underwriter can choose from for an insurance policy under the Architects and Engineers program. The web page 254a provides a navigation menu 280 similar to the menu 206 of producer GUI 122 (FIG. 5). In additional, web page 254a provides a underwriter's menu 282 that provides links to web pages that provides functions that are useful to the underwriters. For example, web page 254a displays options related to amendment to deductible expense 284 and employment practices liability endorsement 286. The underwriter can choose from different types of endorsements and enter different amounts of endorsements. These information affect the premium rates.

When the producer uses producer GUI 122 to review the quote generated by the underwriter, GUI 122 displays the endorsements and limitations configured by the underwriter, but does not show what options the underwriter can choose from.

The web pages of broker GUI 124 can be designed in a manner similar to the web pages of the producer GUI 122 or underwriter GUI 126. In one example, producer GUI displays a subset of information that the broker GUI 124 can displays, and the broker GUI 124 displays a subset of information that the producer GUI 122 can display.

An advantage of system 120 is that after the producer enters the applicant's information, system 120 automatically searches broker data 128 and finds a broker having a surplus lines license in the relevant jurisdiction and having a broker agreement with the insurance company. In a version of marketplace 10 where server 100 maintain information on multiple insurance companies, system 120 automatically finds an insurance company that provides the type of insurance coverage sought by the applicant, and finds a broker having a surplus lines license in the relevant jurisdiction and having a broker agreement with the insurance company.

Another advantage of system 120 is that by providing producer GUI 122, broker GUI 124, and underwriter GUI 126 in the form of web pages, different parties can collaborate in a convenient and efficient manner. Any producer who has access to the Internet can participate in the insurance marketplace 18. A producer, who previously has no contractual agreements with an insurance company, can use system 120 to form a binding insurance agreement with the insurance company in a manner that complies with the surplus lines regulations.

Another advantage of system 120 is that a reduced amount of paper is sent among different parties. System 120 functions as a central depository of information and documents. When an applicant's information is entered by the producer, the information is saved in database 200, and can be retrieved by the broker or underwriter through a web browser. The comments entered by the producer, broker, or underwriter are also saved by system 120 and made available for review. Paper documents (e.g., printed quotes and policies) are mailed when the documents have been finalized and are ready to be signed. Intermediate versions of the documents are processed electronically.

It is to be understood that the foregoing description is intended to illustrate and not to limit the scope of the invention, which is defined by the scope of the appended claims. For example, different jurisdictions may have different requirements concerning the processing of surplus lines insurance policies, so process 140 is modified accordingly. Network 18 can be a proprietary network. Server 100 may belong to a group of insurance companies. In this situation, system 120 not only automatically finds a broker licensed within the relevant jurisdiction, also automatically finds an underwriter working for an insurance company that has a brokerage agreement with the broker. In some jurisdictions, the producer can sign the due diligence affidavit after the insurance policy has been signed by the applicant and the underwriter. In this case, the process 140 of FIGS. 3 and 4 can be modified accordingly.

System 120 can be used to create an insurance marketplace in which there is a need to find a specialized broker. System 120 provides user-friendly GUIs that allow different parties to access the insurance marketplace through the Internet. Producers, brokers, and underwriters who reside in geographically diverse locations and who previously have no relationship with one another can be brought together. System 120 automatically matches a producer with a broker (and with an insurance company if there are more than one insurance company), so that a transaction relating to the purchase of insurance coverage may be efficiently completed.

Other embodiments are within the scope of the following claims.

1. A computer implemented method comprising:
receiving at a server a request from an insurance producer, operating in a first jurisdiction, to place an insurance policy of a specific type in the first jurisdiction; and
transmitting to the producer, in response to the request, authorization from a broker who is licensed in the first jurisdiction to produce the insurance policy.

2. The method of claim 1, further comprising, in response to the request at the server, automatically identifying one or more brokers who are licensed to place the specific type of insurance policy in the first jurisdiction.

3. The method of claim 1, wherein the insurance producer is not licensed in the first jurisdiction to broker insurance policies of the specific type.

4. The method of claim 1, further comprising providing a graphical user interface (GUI) to the insurance producer to allow the insurance producer to enter the request.

5. The method of claim 4 wherein the GUI allows the insurance producer to enter information related to an insured entity of the insurance policy.

6. The method of claim 4 wherein the GUI is provided to the producer over the Internet.

7. The method of claim 4 wherein the GUI is configured to be displayed by an Internet browser.

8. The method of claim 1 wherein the insurance policy comprises a surplus lines insurance policy.

9. The method of claim 8 wherein the surplus lines insurance policy includes a property and casualty insurance policy.

10. The method of claim 1 wherein identifying the broker comprises providing a database containing information sufficient to identify brokers who are licensed in the first jurisdiction to place policies of the specific type.

11. The method of claim 10 wherein the database identifies brokers who have surplus lines broker's licenses in the first jurisdiction.

12. The method of claim 11 wherein the database identifies brokers who have surplus lines broker's licenses in a second jurisdiction.

13. The method of claim 1, further comprising providing a database containing information describing legal requirements for placing policies of the specific type in the first jurisdiction.

14. The method of claim 13 wherein the database contains information describing legal requirements for placing policies of the specific type in a second jurisdiction.

15. The method of claim 13, further comprising, at the broker, satisfying the legal requirements described in the database.

16. The method of claim 15, further comprising determining whether the insurance policy is exempt from a legal requirement described in the database.

17. The method of claim 16 wherein determining whether the insurance policy is exempt from a legal requirement comprises determining whether the specific type of insurance policy is listed on an export list that specifies the types of insurance that are exempt from a diligent search requirement.

18. The method of claim 17 wherein determining whether the insurance policy is exempt from a legal requirement comprises determining whether an insured entity qualifies for an industrial insured exception.

19. The method of claim 13, further comprising, generating an affidavit or declaration to be signed by the producer or a representative of the producer, said affidavit or declaration being generated based on the legal requirements described in the database.

20. The method of claim 19 wherein the affidavit or declaration contains a statement specifying that the broker was not able to find an insurance company licensed to provide insurance policies of the specific type in the first jurisdiction.

21. The method of claim 1, further comprising generating the insurance policy and relevant documents according to regulatory requirements of the first jurisdiction related to insurance policies of the specific type.

22. The method of claim 21 wherein the relevant documents comprise an affidavit or declaration that contains a statement specifying that the broker was not able to find an insurance company licensed to provide insurance policies of the specific type in the first jurisdiction to underwrite the insurance policy.

23. The method of claim 21 wherein the relevant documents comprise a tax form for paying tax related to the insurance policy.

24. The method of claim 1 further comprising rating the insurance policy based on a set of guidelines.

25. The method of claim 24, further comprising notifying an underwriter who underwrites the insurance policy when the insurance policy does not satisfy the set of guidelines.

26. The method of claim 25, further comprising providing a graphical user interface (GUI) to the underwriter to allow the underwriter to rate the insurance policy when the insurance policy does not satisfy the set of guidelines.

27. The method of claim 26, further comprising providing a GUI to the broker to allow the broker to modify the insurance policy.

28. The method of claim 1, further comprising placing the insurance policy with an insurance company that is not licensed to underwrite insurance policies in the first jurisdiction.

29. The method of claim 1, further comprising sending a message to an underwriter of the insurance policy indicating that the insurance policy needs to be renewed.

30. The method of claim 29, further comprising sending an approval to the producer indicating that a renewal of the insurance policy has been approved.

31. The method of claim 1, further comprising registering an insured entity of the insurance policy with a reservation system to notify producers or brokers that are affiliated with the producer who produced the insurance policy that the insured entity has already been contacted regarding the insurance policy.

32. A method comprising:
receiving at a server computer a request from an insurance producer who is not licensed to place insurance policies to insure risks of a specific type in a jurisdiction, to place an insurance policy of the specific type in the jurisdiction;
forwarding the request to a broker who is licensed to place the insurance policy of the specific type in the jurisdiction; and
receiving from the broker authorization to produce the insurance policy.

33. The method of claim 32, further comprising automatically identifying one or more brokers who are licensed to place the insurance policy of the specific type in the jurisdiction.

34. The method of claim 32, further comprising automatically identifying one or more insurance companies that are eligible to provide the insurance policy of the specific type in the jurisdiction.

35. The method of claim 34 wherein receiving from the broker authorization to produce the insurance policy comprises receiving from the broker authorization that the broker received from the identified insurance company for producing the insurance policy.

36. The method of claim 32, further comprising receiving at the server a selection by the producer of a broker from the one or more identified brokers.

37. The method of claim 32, further comprising providing a graphical user interface (GUI) to the insurance producer to allow the insurance producer to enter the request.

38. The method of claim 37 wherein the GUI allows the insurance producer to enter information related to an insured entity of the insurance policy.

39. The method of claim 37 wherein the GUI is provided to the producer over the Internet.

40. The method of claim 39 wherein the GUI is configured to be displayed by an Internet browser.

41. The method of claim 32 wherein the insurance policy comprises a surplus lines insurance policy.

42. The method of claim 32 wherein determining the broker comprises searching a database containing contact information of brokers who have surplus lines broker's licenses.

43. The method of claim 42 wherein the database contains contact information of brokers who have non-resident surplus lines broker's licenses in the jurisdiction.

44. The method of claim 32, further comprising generating the insurance policy according to a set of rules so that the insurance policy satisfies insurance regulations of the jurisdiction.

45. The method of claim 32, further comprising generating the insurance policy according to a set of rules so that the insurance policy satisfies surplus lines insurance regulations of the jurisdiction.

46. The method of claim 32, further comprising determining whether the insurance policy is exempt from a diligent search requirement that requires the broker to search for insurance companies licensed in the jurisdiction to underwrite the insurance policy.

47. The method of claim 46 wherein determining whether the insurance policy is exempt from the diligent search requirement comprises determining whether the risk of the specific type is listed on an export list that specifies the types of insurance that are exempt from the diligent search requirement.

48. The method of claim 46 wherein determining whether the insurance policy is exempt from the diligent search requirement comprises determining whether an insured entity qualifies for an industrial insured exception that specifies the types of insured entities that are exempt from the diligent search requirement.

49. The method of claim 46, further comprising, when the insurance policy is not exempt from a diligent search requirement, generating an affidavit or declaration that contains a statement specifying that the broker was not able to find an insurance company licensed to provide insurance policies of the specific type in the first jurisdiction to underwrite the insurance policy.

50. The method of claim 32, further comprising generating the insurance policy and relevant documents according to regulatory requirements of the first jurisdiction related to insurance policies of the specific type.

51. The method of claim 50 wherein the documents comprise an affidavit or declaration that contains a statement specifying that the broker was not able to find an insurance company licensed to provide insurance policies of the specific type in the first jurisdiction to underwrite the insurance policy.

52. The method of claim 50 wherein the documents comprise a tax form for paying tax related to the insurance policy.

53. The method of claim 32, further comprising rating the insurance policy based on a set of guidelines.

54. The method of claim 53, further comprising notifying an underwriter who underwrites the insurance policy when the insurance policy does not satisfy the set of guidelines.

55. The method of claim 54, further comprising providing a graphical user interface (GUI) to the underwriter to allow the underwriter to rate the insurance policy when the insurance policy does not satisfy the set of guidelines.

56. The method of claim 32, further comprising placing the insurance policy with an insurance company that is not licensed to underwrite insurance policies of the specific type in the first jurisdiction.

57. The method of claim 32, further comprising sending a message to an underwriter of the insurance policy indicating that the insurance policy needs to be renewed.

58. The method of claim 57, further comprising sending an approval to the producer indicating that a renewal of the insurance policy has been approved.

59. The method of claim 32, further comprising registering an insured entity of the insurance policy with a reservation system to notify producers or brokers that are affiliated with the producer who produced the insurance policy that the insured entity has already been contacted regarding the insurance policy.

60. A computer implemented method comprising:
receiving at a server a request from an insurance producer to place a surplus lines insurance policy with an insurance company;
automatically identifying one or more brokers who are licensed to place the surplus lines insurance policy;
automatically identifying one or more insurance companies that are eligible to provide the surplus lines insurance policy; and
transmitting to the producer authorization from one of the identified insurance companies to produce the insurance policy.

61. The method of claim 60 in which transmitting to the producer authorization from one of the identified insurance companies comprises transmitting to one of the identified brokers the authorization from the identified insurance company, and transmitting to the producer the authorization from the identified broker.

62. A server system, comprising:
a first interface for receiving from a producer over a network a request to place an insurance policy of a specific type in a jurisdiction, and to transmit to the producer, in response to the request, authorization from an insurance broker who is licensed in the jurisdiction to produce the insurance policy.

63. The server system of claim 62, further comprising a processing engine configured to identify one or more brokers licensed in the first jurisdiction to place insurance policies with an insurance company not licensed to insure risks of the specific type in the jurisdiction.

64. The server system of claim 62, further comprising a second interface for providing information about a received request to the insurance broker.

65. The server system of claim 62, further comprising a third interface for providing information about a received request to an insurance underwriter and to allow the insurance underwriter to authorize production of the insurance policy.

66. The server system of claim 62, further comprising a database containing contact information of at least one broker who has a surplus lines broker's license in the jurisdiction.

67. The server system of claim 62, further comprising a rating engine to rate the insurance policy when the request to place the insurance policy of the specific type meets a set of insurance guidelines.

68. The server system of claim 62, further comprising a database having templates of surplus lines insurance policies.

69. The server system of claim 68 wherein the templates of surplus lines insurance policies comprises different templates of a common type of insurance policy to satisfy the insurance regulations or laws of different jurisdictions.
